(19) United States
(12) Patent Application Publication
(10) Pub. No.: US 2009/0261949 A1
(43) Pub. Date: Oct. 22, 2009

(54) Mobile communication terminal with IC tag reader

(76) Inventor: Hitoshi Hara, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/213,976

(22) Filed: Jun. 26, 2008

(30) Foreign Application Priority Data
Apr. 18, 2008 (JP) 2008-2501

(51) Int. Cl. H04B 7/00

(52) U.S. Cl. 340/10.1

(57) ABSTRACT

The object of the present invention is to provide with a mobile communication terminal with IC tag reader capable of having smaller scale less than that of the conventional apparatus for the multi built-in RFID tag and reading out data in conformity with at least two RFID protocols, ISO-15693 and IDO 14443, without switching operations. The terminal comprises: a memory 16 for storing at least one group consisting of protocol IDs identifying protocol, the IDs being arranged in a certain order; an operation input means 13 for allowing a user to designate any of the group of the protocol IDs; a controller 12 for reading a member of the designated protocol IDs, from the top in turn, from the memory 16 and sending it; a wireless reader means having a plurality of circuits which are capable of being switched and connected respectively, in order to perform wireless communication in conformity with respective RFID protocols identified by at least one group of the RFID protocol IDs stored in the memory.

### BACKGROUND OF THE INVENTION

1. Technical Field

The present invention relates to a mobile communication terminal with IC tag reader for reading out data from a plurality of RFID tags working in conformity with different standard respectively.

2. Description of Related Art

Owing to convenience such as traceability, RFID (Radio Frequency IDentification) tags are used and widely spread in the field of delivery, transportation and so on. However, difference between the standards (so-called protocols; hereinafter, referred to as “RFID protocol.”) which are defined locally recently may be obstacles against the usage of these RFID tags. For example, while ISO-15693 is going to be popular in USA and Europe, ISO-1443 and the like is a major candidate in Japan.

Conventionally, it is known that a RFID tag (hereinafter, referred to as “multi built-in RFID tag.”) has a plurality of built-in RFID tag means working in conformity with different RFID protocol respectively. In the Patent document 1, it is suggested that in order to read out data from the multi built-in RFID tag, one apparatus has IC tag readers for respective RFID protocols.

[Patent document 1] Japanese Patent Application Laid-Open Publication No. 2007-334703

However, the conventional apparatus for the multi built-in RFID tag described in the Patent document 1 has problem that this apparatus becomes large and deteriorates its operability. This is because of necessity of IC tag readers for the respective RFID protocols and of detecting the appropriate RFID protocol.

### SUMMARY OF THE INVENTION

Considering the aforementioned state of art, the object of the present invention is to provide with a mobile communication terminal with IC tag reader capable of having smaller scale less than that of the conventional apparatus for the multi built-in RFID tag and reading out data in conformity with at least two RFID protocols, ISO-15693 and IDO 14443, without switching operations.

The present invention provides following configurations in order to achieve the aforementioned objective.

(1) The present invention of claim 1 provides a mobile communication terminal with IC tag reader comprising: a memory for storing one or a plurality of group(s) of RFID protocol IDs identifying respective RFID protocols, RFID protocol IDs being stored in a predetermined order within each group; an operation input means for allowing a user to operate and input data, the operation including that for designating a group of RFID protocol IDs; a protocol adaptive controller for reading out the designated the group of RFID protocol IDs from the top in turn from the memory and for outputting them; and a wireless reader means having circuits which are capable of being switched and connected respectively, in order to perform wireless communication in conformity with respective RFID protocols identified by at least one group of the RFID protocol IDs stored in the memory; wherein the wireless reader means performs the switching responding to the RFID protocol ID output from the protocol adaptive controller.
(2) The present invention of claim 2 provides a mobile communication terminal with IC tag reader of claim 1, further comprising a display for displaying for certain information, wherein the memory stores certain RFID protocols accompanied with RFID protocol ID; and the protocol adaptive controller controls the display to display the RFID protocol stored in the memory, extracts from the memory the RFID protocol ID corresponding to the RFID protocol designated via the operation input means, and outputs it to the wireless reader means with higher priority.
(3) The present invention of claim 3 provides a mobile communication terminal with IC tag reader of claim 1, wherein the protocol adaptive controller, for each group of RFID protocol ID designated via the operation input means, when data is not read out successively via wireless communication in conformity with the entire RFID protocols identified by the input group of the RFID protocol IDs, controls the display to display the entire RFID protocols identified by the group of the RFID protocol IDs.
(4) The present invention of claim 4 provides a mobile communication terminal with IC tag reader of claim 1, wherein the protocol adaptive controller reads the group of the RFID protocol IDs predetermined depending on the usage area, and outputs each RFID protocol ID to the wireless reader means in turn when an operation for read out data is performed via the operation input means.

According to the invention of claim 1, it is possible to have small scale less than that of the conventional apparatus for the multi built-in RFID tag and reading out data in conformity with at least two RFID protocols, ISO-15693 and IDO 14443, without switching operations, hence the mobile communication terminal with IC tag reader comprises: a memory for storing one or a plurality of group(s) of RFID protocol IDs identifying respective RFID protocols, RFID protocol IDs being stored in a predetermined order within each group; an operation input means for allowing a user to operate and input data, the operation including that for designating a group of RFID protocol IDs; a protocol adaptive controller for reading out the designated the group of RFID protocol IDs from the top in turn from the memory and for outputting them; and a wireless reader means having circuits which are capable of being switched and connected respectively, in order to perform wireless communication in conformity with respective RFID protocols identified by at least one group of the RFID protocol IDs stored in the memory; wherein the wireless reader means performs the switching responding to the RFID protocol ID output from the protocol adaptive controller.

According to the invention of claim 2, in addition to the aforementioned advantage of claim 1, when the RFID protocol is known, efficiency of the operation can be improved by inputting the corresponding RFID protocol, hence a mobile communication terminal with IC tag reader of claim 2 further comprises a display for displaying for certain information, wherein the memory stores certain RFID protocols accompanied with RFID protocol ID; and the protocol adaptive controller controls the display to display the RFID protocol stored in the memory, extracts from the memory the RFID protocol ID corresponding to the RFID protocol designated via the operation input means, and outputs it to the wireless reader means with higher priority.

According to the invention of claim 3, in addition to the aforementioned advantage of claim 1, hence the protocol adaptive controller, for each group of RFID protocol ID designated via the operation input means, when data is not read out successively via wireless communication in conformity with the entire RFID protocols identified by the input group of the RFID protocol IDs, controls the display to display the entire RFID protocols identified by the group of the RFID protocol IDs.

According to the invention of claim 4, in addition to the aforementioned advantage of claim 1, hence the protocol adaptive controller reads the group of the RFID protocol IDs predetermined depending on the usage area, and outputs each RFID protocol ID to the wireless reader means in turn when an operation for read out data is performed via the operation input means.

### BRIEF DESCRIPTION OF THE DRAWINGS

FIG. 1 is a block diagram schematically illustrating an example of an IC tag reader system according to the present invention.

FIG. 2 is a block diagram schematically illustrating an example of the mobile communication terminal with IC tag reader according the present invention.

FIG. 3 is a block diagram schematically illustrating another example of the IC tag reader system according to the present invention.

### DETAILED DESCRIPTION OF THE PREFERRED EMBODIMENTS

Hereinafter, referring to the accompanying drawings, descriptions are made on embodiments according to the present invention.

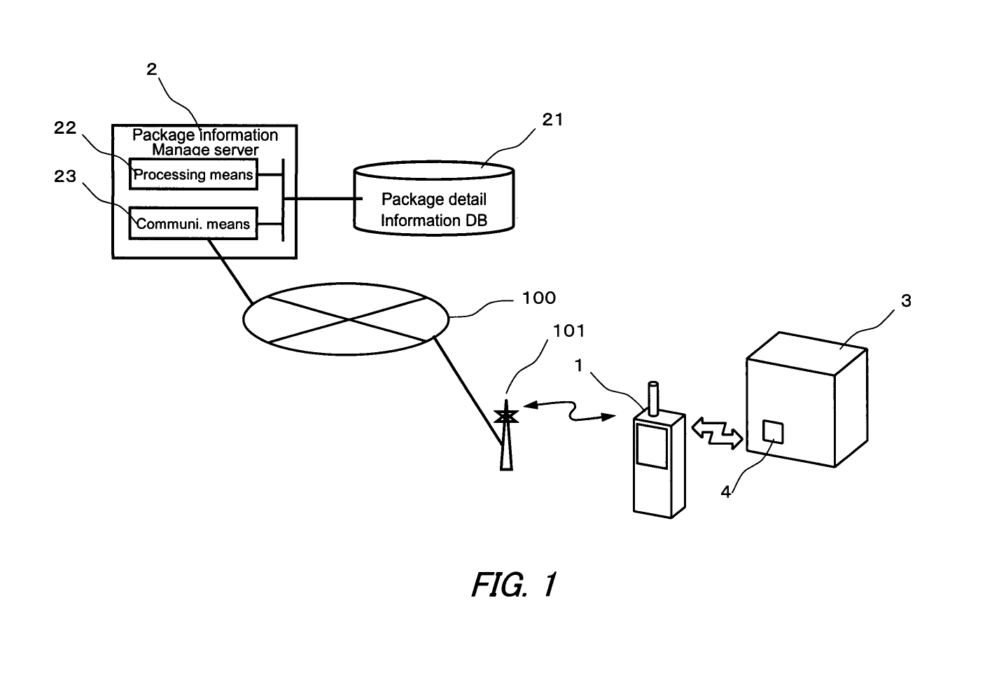

FIG. 1 is a block diagram schematically illustrating an example of an IC tag reader system according to the present invention. The IC tag reader system according to the present invention has a mobile communication terminal with IC tag reader 1 for reading out a certain storage data from a RFID tag 4 attached to a package 3. The system also has a package information manage server 2 connected with the mobile communication terminal with IC tag reader 1 over a network 100 such as the internet and for managing information (hereinafter, referred to as “package detail information.”) on the detail of the package 3.

Here, the package 3 represents precision machines, electric and/or electronic apparatuses/devices, information and/or communication apparatuses/devices, and transport machines; and the transport machines are considered to include a car, a cargo, a carrying plate, a carrying container, a package, and the like. The mobile communication terminal with IC tag reader 1 is capable of the communication over the network 100 via a base station 101.

The RFID tag 4 has a non-volatile memory with, for example, a memory capacity of 256 byte; and the non-volatile memory has a plurality of certain memory areas. In the first memory area, an address is stored that identifies, for example, the package information manage server 2 on the network 2 (hereinafter, the address is referred to as “server access information.”). In the second memory area, information is stored, for example, that identifies the package 3 (hereinafter, the information is referred to as “package ID.”). Via this package ID, the user of the mobile communication terminal with IC tag reader 1 is obtainable the aforementioned package detail information. Regarding the first and second memory areas, writing, erasing and changing the data can only be allowed under a certain privilege.

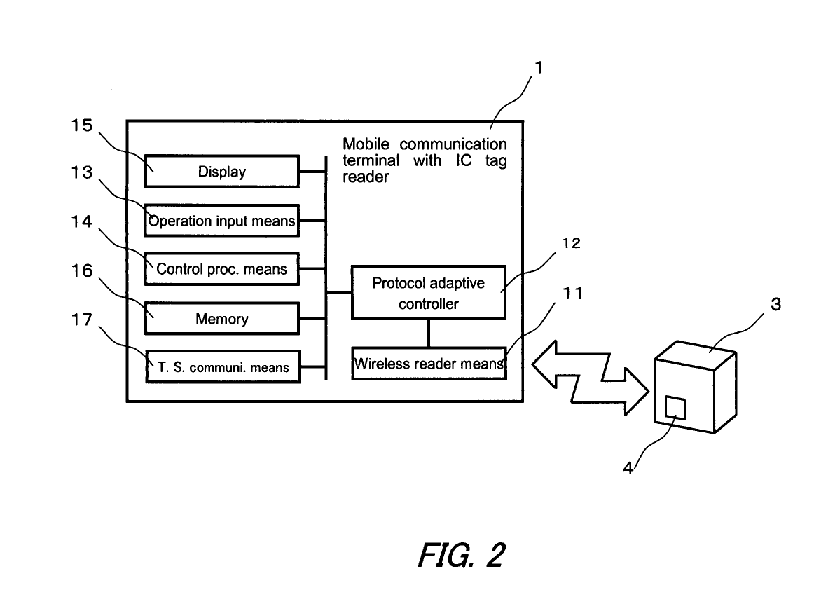

FIG. 2 is a block diagram schematically illustrating an example of the mobile communication terminal with IC tag reader according the present invention. The mobile communication terminal with IC tag reader 1 comprises, as shown in the FIG. 2, a first part 11, 12 for reading out the stored data from the RFID tag 4, and a second part 13-17 for realizing the ordinary function for mobile cells and another one described below.

The first part has a wireless reader means 11 for reading out data stored in the RFID tag 4 by means of the wireless communication, and a protocol adaptive controller 12 for outputting information identifying the RFID protocol to the wireless reader means 11 (hereinafter, this information is referred to as “RFID protocol ID.”).

The wireless reader means 11 is capable of realizing, for example, wireless communication via an antenna for magnetic flux coupling or electromagnetic coupling; namely, it is capable of the wireless communication with a passive tag by supplying electric power, an active tag, and/or the like. The wireless reader means 11 has a plurality of circuits, such as a signal generator(s), a power generating circuit(s), a controller(s), a detection circuit(s), and the like for communicating in conformity with certain RFID protocols.

Here, a certain circuit(s) compatible with the other one for the different RFID protocol is eliminated, while the representative circuit is remained. Each aforementioned circuit is switched depending on the RFID protocol ID input from the protocol adaptive controller 12. Each detection circuit is capable of outputting the stored information read out from the RFID tag 4 to the protocol adaptive controller 12.

The protocol adaptive controller 12 is capable of performing protocol control that selects a RFID protocol ID to output it to the wireless reader means 11 and thereby switching the circuits for the wireless communication. Here, the RFID protocol IDs used for the protocol control are stored in a memory 16 as a group consisting of the IDs in a certain order, in advance. In addition, there may be a plurality of groups of the RFID protocol IDs; hereinafter, descriptions are based on a plurality of groups.

The protocol adaptive controller 12, in order to allow the user to designate any of these groups, displays for example information for identifying the groups (hereinafter, referred to as “group ID.”) in the display 15. In a certain case, the protocol adaptive controller 12 may also control to display one or more RFID protocol ID(s), from the top, with the corresponding group ID. The protocol adaptive controller 12 is operable to perform the protocol control as follows when the group ID is designated. The control is continued after respective detections of failure of the wireless communication in the order of RFID protocol ID(s) within the group, until achieving the success of the communication via the wireless reader means 11.

Here, the protocol adaptive controller 12 may output the RFID protocol ID designated via an operation input means 13 first. This designation can also be performed, for example, by way of that the protocol controller 12 displays the RFID protocol stored in the memory 16. In this case, the protocol adaptive controller 12 is configured to select the RFID protocol corresponding to the one designated by the operation input means 13 from the memory and output it.

It is preferable that the RFID protocol ID is arranged, as a default, with a high priority corresponding to the area, country, region, and the like where the mobile communication terminal with IC tag reader 1 is used, in advance. Thereby, a user can obtain data from the RFID tag 4 without consciousness of the RFID protocol. Besides, when a suitable RFID protocol is known in advance, the corresponding RFID protocol ID can be input as described above.

The second part includes: an operation input means 13 allowing the user to operate and input data; a control processing means 14 capable of performing certain control, data processing, and so on; a display 15 for displaying a certain data; a memory 16 for storing data; and a mobile terminal side communication means 17 capable of communicating over the network 100 via a base station 101.

The operation input means 13 allows the use, in addition to the ordinary key operations and data input, to designate the group ID identifying the group of the RFID protocols, input of the RFID protocol ID, and operate for starting the read-out of the stored information from the RFID tag 4, and so on. Besides, the operation input means 13 may also allow a user to change the order of the RFID protocol IDs stored in the memory 16.

The display 15 has an ordinary displaying function and displays data such as the selectable group IDs, the RFID protocol input via the operation input means 13, and the like. The display 15 also displays the server access information and the package ID read out from the tag 4, notification of failure of reading out data, corresponding RFID protocol ID, and so on.

The memory 16 stores the aforementioned group ID with the accompanying RFID protocol IDs. Here, each RFID protocol ID is also stored with its corresponding RFID protocol. In the configuration that the group of the RFID protocol IDs is allowed to be designated as a default, the memory 16 stores the protocol ID identifying the group.

The mobile communication terminal with IC tag reader 1 thus configured operates as follows. Firstly, the control processing means 14 detects key operations for reading out data from the RFID tag 4, the operations input via the operation input means 13. When the key operations for reading out data are detected, the control processing means 14 outputs a signal (hereinafter, referred to as “detected data reading signal.”) notifying the event to the protocol adaptive controller 12.

Here, certain information such as group ID and so on can be attached to the aforementioned key operations for reading data. In addition to the group ID, the other information such as a certain RFID protocol ID may also be attached. The attached information (hereinafter, referred to as “attached read-out information.”) is output by way of the control processing means 14 to the protocol adaptive controller 12.

Next, the protocol adaptive controller 12 decides whether the attached read-out information is attached or not when the detected data reading signal is input from the control processing means 14. When the attached read-out information is attached, the protocol adaptive controller 12 reads out the RFID protocol ID from the memory 16 based on the attached read-out information.

When the attached read-out information is the group ID, the protocol adaptive controller 12 reads out a member of the group of the RFID protocol ID from the memory 16 and outputs it, from the top in turn. When the attached read-out information is the RFID protocol ID, the protocol adaptive controller 12 outputs this RFID protocol ID to the wireless reader means 11. When the attached read-out information is not attached, the protocol adaptive controller 12 reads out the default RFID protocol ID or a member of the default group of the RFID protocol ID and outputs it to the wireless reader means 11, from the top in turn.

Next, the wireless reader means 11 switches and connects the aforementioned circuits, so as to enable the wireless communication in accordance with the RFID protocol ID. Here, when circuits connected this way already exists, the connected circuits are designated. The wireless reader means 11, next, reads out the server access information and the package ID from the RFID tag 4 by means of the wireless communication.

Hereat, in order to read out data from the RFID tag 4, the wireless reader means 11 performs certain process (hereinafter, referred to as “read out process.”) in compliance with the RFID protocol. The wireless reader means 11, when having successfully read out the server access information and the package ID in the read out process, outputs these read out data to the protocol adaptive controller 12. When having unsuccessfully read out data in the read out process, the wireless reader means 11 outputs disable signal notifying this event to the protocol adaptive controller 12.

Next, the protocol adaptive controller 12 reads out the next RFID protocol ID from the memory 16 and outputs to the wireless reader means 11 when being input the disable signal from the wireless reader means 11. Here, the protocol adaptive controller 12 displays the message notifying the disability of reading out data on the display 15 when the disable signal was input against the RFID protocol ID contained in the attached read-out information.

The protocol adaptive controller 12 also displays the message notifying the disability of reading out data on the display 15 when the disable signal was input against the last RFID protocol ID of a certain group. Here, the protocol adaptive controller 12 may further control to display the entire RFID protocols ID, each specified by the corresponding member of the group.

Next, the protocol adaptive controller 12, when having been input the server access information and the package ID from the wireless reader means 11, stores these information to the memory 16. Next, the protocol adaptive controller 12 accesses via the mobile terminal side communication means 17 to the package information manage server 2 identified by the server access information stored in the aforementioned process, and sends the package ID to it.

Here, the package information manage server 2, when being accessed by the mobile communication terminal with IC tag reader 1, searches the package detail information corresponding to the package ID attached and sends the information so as to allow a use to browse it via the mobile communication terminal with IC tag reader 1. The protocol adaptive controller 12 displays the sent detail package information on the display 15. The user of the mobile communication terminal with IC tag reader 1 is capable of browsing the package detail information by operating the operation input means 13 by way of such as scrolling the image displayed on the display 15.

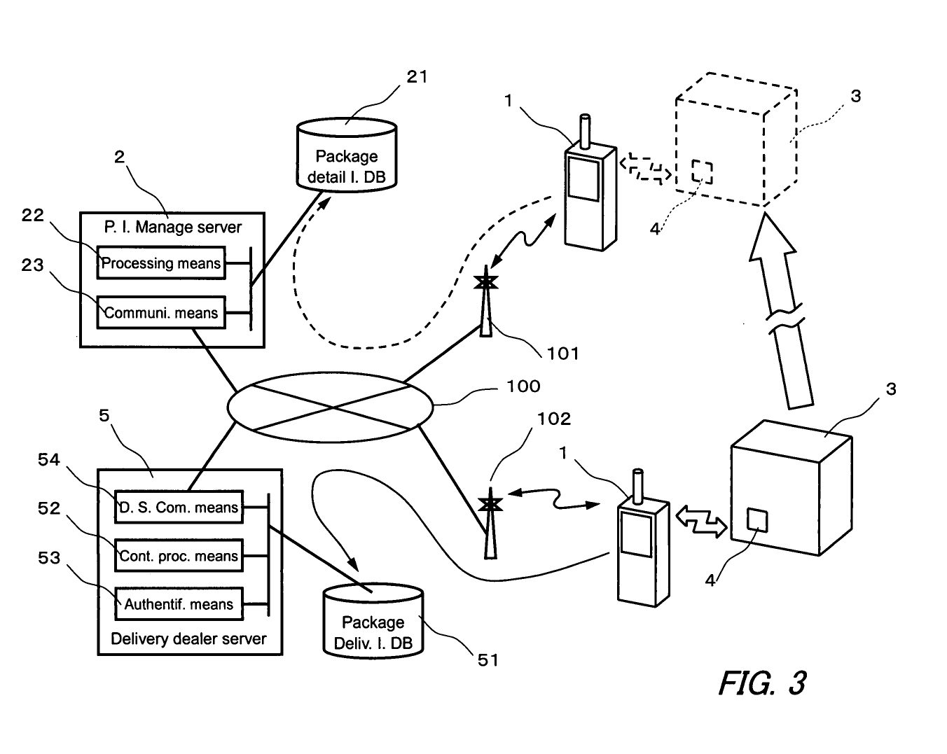

FIG. 3 is a block diagram schematically illustrating another example of the IC tag reader system according to the present invention. A new server, delivery dealer server, 5 is communicatively connected to the network 100, in the IC tag reader system shown in FIG. 3, wherein the delivery dealer server 5 is provided by a dealer delivering the package 3.

The delivery dealer server 5 comprises: a database 51 for storing information on the delivery of the package 3 (hereinafter, this database is referred to as “package delivery information database” and the stored information is referred to as “package delivery information.”); a control processing means 52 for performing a certain control responding an access and thereby being capable of providing the package delivery information; an authentification means 53 for authenticating in a certain case; and a dealer side communication means 54 capable of communicating with the mobile communication terminal with IC tag reader 1 of the user of the dealer.

Hereafter, the address of the delivery dealer server 5 is considered to be stored in the memory 16, in advance. Beside, prior to the delivery, regarding each package to be delivered or each delivery, package delivery information is considered to be prepared in the dealer side and stored in the package delivery information database, with the corresponding delivery package ID. The package delivery ID is stored in a third rewritable address of the RFID tag 4 attached to the corresponding package 3.

Here, the package delivery information includes such as a name of the package, a name of destiny, a delivery address, a delivery deadline, a client name, a client address, client contact information, and so on. Further, regarding the delivery to the distant, overseas, and so on, the package delivery information includes a name of an export facility such as a port, an airport, a name of the transport dealer, shipping departure ID, a departure and/or arrival time, and so on, depending on necessity.

Now, descriptions are performed on the operation of the mobile communication terminal with IC tag reader of the example shown in FIG. 3. The protocol adaptive controller 12, responding to the operation of the user, reads out the delivery package ID written in the aforementioned third memory area by controlling the wireless reader means 11. Next, the protocol adaptive controller 12 reads out the address of the delivery dealer server 5 stored in the memory 16, accesses it 5 via mobile terminal side communication means 17, and receives the package delivery information corresponding to the delivery package ID. Thereby, the dealer is capable of obtaining information such as the name of the delivery package, the name of destiny, the delivery address, and so on, and improving the operability at the transferring of the package and so on.

The mobile communication terminal with IC tag reader enables to read information from the RFID tag working in conformity with different RFID protocols, tag attached to machines, electric apparatuses/devices, precision machines, and the like to be transported as well as a carrying plate, a carrying container, a package, a car and a cargo; and the terminal is available in the transportation industry, manufacturing industry of electronic parts, information and/or communication apparatuses/devices, and so on.

What is claimed is:

1. A mobile communication terminal with IC tag reader comprising:
a memory for storing one or a plurality of group(s) of RFID protocol IDs identifying respective RFID protocols, RFID protocol IDs being stored in a predetermined order within each group;
an operation input means for allowing a user to operate and input data, the operation including that for designating a group of RFID protocol IDs;
a protocol adaptive controller for reading out the designated the group of RFID protocol IDs from the top in turn from said memory and for outputting them; and
a wireless reader means having circuits which are capable of being switched and connected respectively, in order to perform wireless communication in conformity with respective RFID protocols identified by at least one group of the RFID protocol IDs stored in said memory;
wherein said wireless reader means performs the switching responding to the RFID protocol ID output from the protocol adaptive controller.

2. The mobile communication terminal with IC tag reader of claim 1, comprising, a display for displaying for certain information, wherein said memory stores certain RFID protocols accompanied with RFID protocol ID; and said protocol adaptive controller controls said display to display the RFID protocol stored in said memory, extracts from said memory the RFID protocol ID corresponding to the RFID protocol designated via said operation input means, and outputs it to said wireless reader means with higher priority.

3. The mobile communication terminal with IC tag reader of claim 1, wherein said protocol adaptive controller, for each group of RFID protocol ID designated via said operation input means, when data is not read out successively via wireless communication in conformity with the entire RFID protocols identified by the input group of the RFID protocol IDs, controls said display to display the entire RFID protocols identified by the group of said RFID protocol IDs.

4. The mobile communication terminal with IC tag reader of claim 1, wherein said protocol adaptive controller reads the group of the RFID protocol IDs predetermined depending on the usage area, and outputs each RFID protocol ID to said wireless reader means in turn when an operation for read out data is performed via said operation input means.
